(19) United States
(12) Patent Application Publication
(10) Pub. No.: US 2022/0351310 A1
(43) Pub. Date: Nov. 3, 2022

(54) REAL ESTATE BUYER AND AGENT CONNECTION SYSTEM AND PROCESS

(71) Applicants: Yves Marie Osme, CAPE CORAL, FL (US); RACHELLE OSME, CAPE CORAL, FL (US)

(72) Inventors: Yves Marie Osme, CAPE CORAL, FL (US); RACHELLE OSME, CAPE CORAL, FL (US)

(21) Appl. No.: 17/243,041

(22) Filed: Apr. 28, 2021

(51) Int. Cl. G06Q 50/16; G06Q 30/06

(52) U.S. Cl. CPC G06Q 50/16; G06Q 30/0617; G06Q 30/0641

(57) ABSTRACT

A computer-implemented buyer and buyer's agent connection process and system wherein a buyer connects via a computer device to a host computer network and after registering is provided with information on properties for sale for prospective viewing and purchasing by the buyer, then providing the buyer with available buyer's agents with profiles to aid the buyer in the selection of a specific agent who is then connected to the buyer in real time.

### FIELD OF THE INVENTION

This invention relates to real estate listing platforms and more particularly a system and process wherein prospective buyers seeking a property can be directly connected to a buyer's agent of their choice.

### BACKGROUND OF THE INVENTION

Buyers who are looking to purchase a property generally desire to be represented by a real estate agent who works for them, commonly referred to as a “BUYER'S AGENT”, rather than work with the listing agent for the property. The latter desire is based on a feeling that a buyer's agent will best represent a buyer's best interests even though the commission for a buyer's agent is usually paid from a seller's proceeds at closing.

Currently, companies which connect buyers with buyer's agents provide a link to the buyer for connecting to a buyer's agent selected by the companies. The buyer has no choice in selecting the buyer's agent. The buyer does not know anything about the buyer's agent or whether the buyer's agent is qualified to handle properties in s selected area or whether the buyer will “click” with the buyer's agent. Also, from a buyer's agent's standpoint the buyer's agent getting the connection does not know whether the buyers are even qualified to purchase properties in the desired price range and thus often waste a lot of time in dealing with such an unqualified buyer. Furthermore, such current modes of connecting buyers to buyer's agents are not live and in real time. Nowadays real estate buyers, like most consumers, operate at “warp” speed and thus expect live and instant access to information when desired.

In view of the above problems, a need exists for a system and process that connects a buyer to a qualified buyer's agent of their choice in a fast and real time manner.

### SUMMARY OF THE INVENTION

The primary object of the present invention is to provide a system and process for connecting buyers to buyer's agents of their choice.

Another object of the present invention is to provide such a system and process that operates in real time to connect buyers and buyer's agents quickly and efficiently.

An additional object is to provide such a system and process which allows both parties, that is, buyers and buyer's agents to qualify each other before proceeding to work together.

The present invention accomplishes the above and other objects by providing a computer-implemented buyer and buyer's agent connection process wherein a buyer who has previously registered connects with a host computer network providing access to a listing of properties for sale by sellers, such as a multiple listing service, who have also previously registered with the host in a desired area via a computer network; the buyer reviewing information about properties and selecting at least one property for prospective purchase; the buyer being connected to data on available buyer's agents who have previously registered with the host to review profiles for consideration; the buyer selecting a buyer's agent; and connecting the buyer and buyer's agent.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a general block flow diagram of the system and process for connection of buyers to buyer agents of the present invention described herein;

FIG. 2 is a more detailed block flow diagram of the system and process for connection of buyers to buyer agents of the present invention described herein; and

FIG. 3 are charts illustrating the type of information that would comprise the database of Buyer/Seller and Buyer's Agents in the computer networks of the real estate host and system.

### DESCRIPTION OF THE PREFERRED EMBODIMENTS

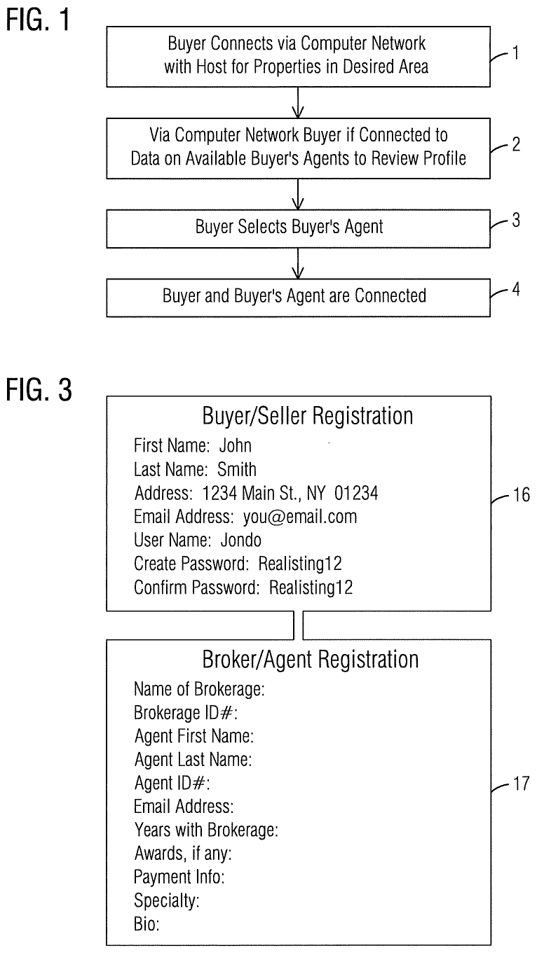

Discussing the process of the buyer/buyer agent's connection system of the present invention, reference is made to the flow diagram of FIG. 1. The process begins with a prospective buyer opening his or her App 1 on a device, such as a smart phone, tablet, laptop or desktop computer and connecting to a host of the process. Once in the app, the prospective buyer registers with the host and completes a profile. Prospective buyers are prequalified or vetted according to predetermined criteria. Once registration has been completed, then the Buyer is provided with information on properties in a desired area for sale by sellers, such as a multiple listing service, who have preregistered with the host 1. Then the buyer is connected to data on available buyer's agents in the desired area who have also preregistered with the host and provided a profile 2. After reviewing the profile the buyer then selects a buyer's agent 3 to work with in seeing a desired property after which the buyer and selected buyer's agent are connected 4.

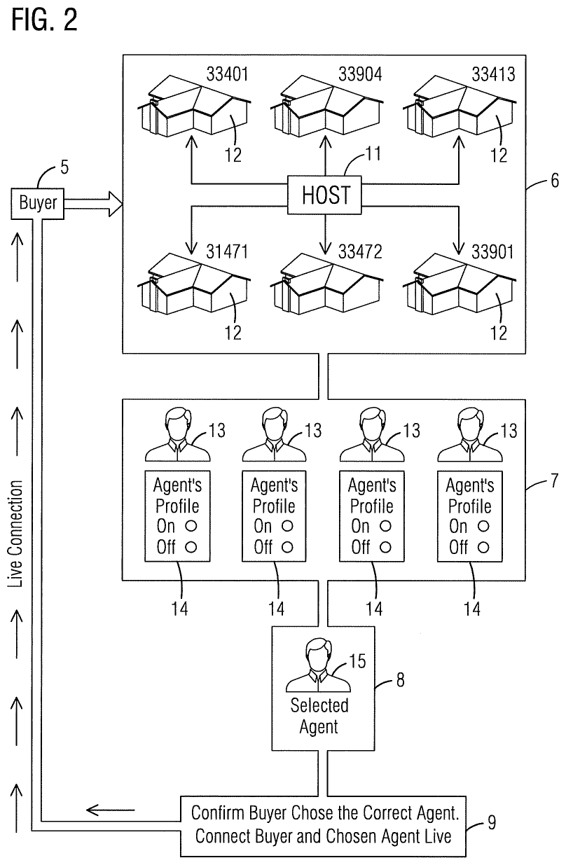

Referring now to FIG. 2, a more detailed block diagram of the process and system is illustrated. As discussed above after a buyer has connected with the host and registered the host 11 provides information on homes 12 in various zip codes matching the desires and requests of the buyer at 6. Then at 7, the buyer reviews the profiles 14 of available buyer's agents provided by the host. Next at 8 the buyer selects an agent 15. Once the selection is confirmed 9 then the buyer 5 and agent 15 are connected live.

FIG. 3 illustrates the registration profiles that prospective buyers and sellers 16 and buyer's agents 17 would provide to the host in order to use the system.

A typical scenario of someone interested in buying a home and starting with conventional real estate websites and then discovering the above system and process might be as follows: Mr. Jones is ready to purchase a home. Therefore, he started searching for properties on other real estate websites, such as Zillow, Realtors, etc. and after searching for hours came across some beautiful potential homes around his price range, but he is not sure if those properties are still available or sales pending. Thus, Mr. Jones is becoming discouraged in his search. Fortunately, he comes across the website and application for this system and after registering with the host he is able to plug in the home address or addresses and can see for himself if the homes are active or pending. In addition he gets a list of real estate brokers who have registered with the host who are currently available to show him the property the same day. He can then review the credentials of the agents and can click on the agent he likes. Once confirmed Mr. Jones automatically receives a call from the agent to discuss the desired property. Now, Mr. Jones can just sit and relax while the agent gathers all the information for him and schedules the showing. Both Mr. Jones and the agent have benefited as Mr. Jones will no longer have to stress about finding properties on his own and the selected buyer's agent benefits from the system by obtaining a qualified buyer.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

I claim:

1. A computer-implemented buyer and buyer's agent connection process comprising:
a. a buyer connecting with a host of properties for sale in a desired area via a computer network;
b. the buyer reviewing information about properties and selecting at least one property for prospective purchase;
c. the buyer being connected to data on available buyer's agents to review profiles for consideration by the buyer in selecting a buyer's agent; and
d. connecting the buyer and buyer's agent.

2. The computer-implemented buyer and buyer's agent connection process of claim 1 further comprising a step before step a. of:
a prospective buyer completing a registration via a computer network with a host to provide a profile of the buyer.

3. The computer-implemented buyer and buyer's agent connection process of claim 1 further comprising a step before step a. of:
a prospective seller completing a registration via a computer network with a host to provide a profile of the seller.

4. The computer-implemented buyer and buyer's agent connection process of claim 1 further comprising a step before step a. of:
a buyer's agent completing a registration via a computer network with a host to provide a profile of the buyer's agent.

5. The computer-implemented buyer and buyer's agent connection process of claim 2 further comprising:
the prospective buyer being vetted and prequalified according to predetermined criteria.

6. A computer-implemented buyer and buyer's agent connection process comprising:
a. a prospective buyer completing a registration via a computer network with a host to provide a profile of the buyer;
b. the prospective buyer being vetted and prequalified according to predetermined criteria;
c. a prospective seller completing a registration via a computer network with a host to provide a profile of the seller;
d. a buyer's agent completing a registration via a computer network with a host to provide a profile of the buyer's agent;
e. a buyer connecting with a host of properties for sale in a desired area via a computer network;
f. the buyer reviewing information about properties and selecting at least one property for prospective purchase;
g. the buyer being connected to data on available buyer's agents to review profiles for consideration by the buyer in selecting a buyer's agent; and
h. connecting the buyer and buyer's agent.

7. A computer-implemented buyer and buyer's agent connection system comprising:
a. a host computer network providing a buyer a list of properties for sale in a desired area via a computer network;
b. the host computer network providing the buyer information on at least one of the properties for prospective purchase;
c. the host computer network providing data on available buyer's agents for consideration by the buyer in selecting a buyer's agent; and
d. the host computer network connecting the buyer and buyer's agent.

8. The computer-implemented buyer and buyer's agent connection system of claim 6 further comprising:
a prospective buyer completing a registration via a computer network with a host to provide a profile of the buyer.

9. The computer-implemented buyer and buyer's agent connection system of claim 6 further comprising:
a prospective seller completing a registration via a computer network with a host to provide a profile of the seller.

10. The computer-implemented buyer and buyer's agent connection system of claim 6 further comprising:
a buyer's agent completing a registration via a computer network with a host to provide a profile of the buyer's agent.

11. A computer-implemented buyer and buyer's agent connection system comprising:
a. a prospective buyer completing a registration via a computer network with a host to provide a profile of the buyer;
b. a prospective seller completing a registration via a computer network with a host to provide a profile of the seller;
c. a buyer's agent completing a registration via a computer network with a host to provide a profile of the buyer's agent;
d. a buyer connecting with a host of properties for sale in a desired area via a computer network;
e. the buyer reviewing information about properties and selecting at least one property for prospective purchase;
f. the buyer being connected to data on available buyer's agents to review profiles for consideration the buyer selecting a buyer's agent; and
g. connecting the buyer and buyer's agent.

12. The computer-implemented buyer and buyer's agent connection process of claim 5 wherein step f. further comprises:
the buyer registering to work with the selected agent.

13. The computer-implemented buyer and buyer's agent connection system of claim 10 wherein f. further comprises:
the buyer being registered to work with the selected agent.
